(19) United States
(12) Patent Application Publication
(10) Pub. No.: US 2014/0026098 A1
(43) Pub. Date: Jan. 23, 2014

(54) SYSTEMS AND METHODS FOR NAVIGATING AN INTERFACE OF AN ELECTRONIC DEVICE

(71) Applicant: Jordan Gilman, Chicago, IL (US)

(72) Inventor: Jordan Gilman, Chicago, IL (US)

(73) Assignee: M2J THINK BOX, INC., Chicago, IL (US)

(21) Appl. No.: 13/553,427

(22) Filed: Jul. 19, 2012

(51) Int. Cl. G06F 3/048

(52) U.S. Cl. 715/810

(57) ABSTRACT

Systems and methods are provided for managing functionalities associated with a dynamic information region of an electronic device. The information region can update with indications of various applications in response to various triggers. Further, the information region can detect selections by a user of the electronic device and display functions associated with the selected application in response to detecting the selections. The user can use various gestures to select the application of the information region or a function of the application, and the electronic device can initiate the application according to the selection. In embodiments, the content in the information region can update from within an application based on switches among interface screens of the application, the receipt of external or internal notifications, user interactions, and/or the like.

### FIELD

This application generally relates to managing functionalities associated with a dynamic navigation menu of an electronic device. In particular, the application relates to platforms and techniques for managing content display and functionality initiation of a navigation menu in response to various triggers.

### BACKGROUND

With the advancement of smart phone and mobile device technologies, manufacturers and developers incorporate functionalities to navigate throughout various applications and menus of the devices. For example, current electronic devices offer a “home” button whereby selecting the home button can return a user interface of the electronic devices to the “home screen,” or perform other pre-set functions. Further, users are able to scroll through various folders or pages of applications using gestures or selection techniques to identify and select a desired application.

However, the pre-set home buttons and selection techniques of existing devices can be limited in their navigational capabilities. In particular, a user may have to scroll through multiple interface screens to select a desired application to initiate. Further, a user is unable to initiate a specific function of an application merely by selecting an icon corresponding to the application from the user interface. Still further, current buttons or icons cannot dynamically display information or dynamically update selectable functions based on changes, notifications, or other triggers to interface screens of an executing application or to the device itself. Moreover, the home button of current electronic devices is typically the most prominent button, but it lacks the ability to both dynamically update and allow users to select specific functions or applications.

Accordingly, there is an opportunity to develop techniques to implement a dynamic menu or region that allows a user to more easily navigate throughout functionalities of a mobile device and that displays relevant information associated with applications of the mobile device.

### SUMMARY

The present embodiments are defined by the appended claims. This description summarizes some aspects of the present embodiments and should not be used to limit the claims.

The foregoing problems are solved and a technical advance is achieved by the use of a dynamic navigation menu of an electronic device. One embodiment is directed to a method in an electronic device. The method includes displaying, on a user interface of the device, an identification of an application of the device, and detecting a selection of the identification by a user via the user interface. Further, the method identifies a set of functions associated with the application in response to the selection and displays, on the user interface in a proximity of the identification, a set of indications associated with the set of functions.

Another embodiment is directed to a method in an electronic device, the method including displaying, in a region of a user interface of the device, a first identification of a first application of the device. Further, the method detects an indication to display a second identification of a second application of the device and, in response to detecting the indication, displays the second identification in the region of the user interface.

A further embodiment is directed to a non-transitory computer readable medium comprising computer instructions embodied thereon to cause a processor of an electronic device to initiate an application of the electronic device and identify a first interface screen associated with the application and displayed on a user interface of the electronic device. The processor further displays an information region that overlays the first interface screen, the information region comprising a first set of information associated with the first interface screen; detects a switch to a second interface screen associated with the application and displayed on the user interface; and updates the information region to overlay the second interface screen and to comprise a second set of information associated with the second interface screen.

### BRIEF DESCRIPTION OF THE DRAWINGS

FIG. 1 illustrates an example electronic device in accordance with some embodiments.

FIGS. 2A-2C illustrate example user interfaces and functions thereof in accordance with some embodiments.

FIGS. 3A-3D illustrate example user interfaces and functions thereof in accordance with some embodiments.

FIG. 4 illustrates an example user interface and functions thereof in accordance with some embodiments.

FIGS. 5A and 5B illustrate example user interfaces and functions thereof in accordance with some embodiments.

FIG. 6 is a block diagram of an electronic device in accordance with some embodiments.

FIG. 7 is a flow diagram depicting user interface functionalities in accordance with some embodiments.

FIG. 8 is a flow diagram depicting user interface functionalities in accordance with some embodiments.

FIG. 9 is a flow diagram depicting user interface functionalities in accordance with some embodiments.

### DETAILED DESCRIPTION

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Systems and methods are disclosed for dynamically modifying an information region or identification on a user interface of an electronic device. The information region can be selectable and can be modified based on various indications or selections, such as user contact, switching of interface screens, time periods, and/or other triggers. According to embodiments, the electronic device can display the information region at any position or location, within any region of the user interface, or as overlaying any interface screen associated with the user interface.

The information region can replace or serve as a substitute or alternative to the conventional “home” button or region on existing mobile devices. For instance, on some existing electronic devices, the home button allows the user to activate the electronic device, navigate to a home screen, or perform other basic and/or pre-set tasks. Other electronic devices can include a home region whereby the user interface displays an icon corresponding to a home function that allows users to navigate to a home screen. However, neither the home buttons nor the home regions allow users to initiate various applications or select functions of applications. Further, neither the home buttons nor the home regions dynamically update with various information or selectable functions associated with various applications or functions of the electronic device.

The systems and methods as discussed herein can offer features tailored to improvements in the usability of electronic devices. With the information region as discussed herein, a user of the electronic device can toggle among applications and functions thereof within the same region of the user interface. Accordingly, the user does not have to navigate through interface screens, folders, or the like to locate and initiate a desired application. Further, the user can initiate a specific function of an application according to various gestures or interactions with the information region. Still further, the information region can indicate any notifications or communications received or detected by an application of the electronic device. Moreover, the information region can dynamically update during an execution of an application to display information or selectable links in response to switches in interface screens of the application. It should be appreciated that other benefits and efficiencies are envisioned. As used herein, an “information region” or “identification” can be understood to include any combination of textual information, icons or graphics, notifications, selectable links or regions, or any other type of selectable or non-selectable visual data that can be displayed on an electronic device.

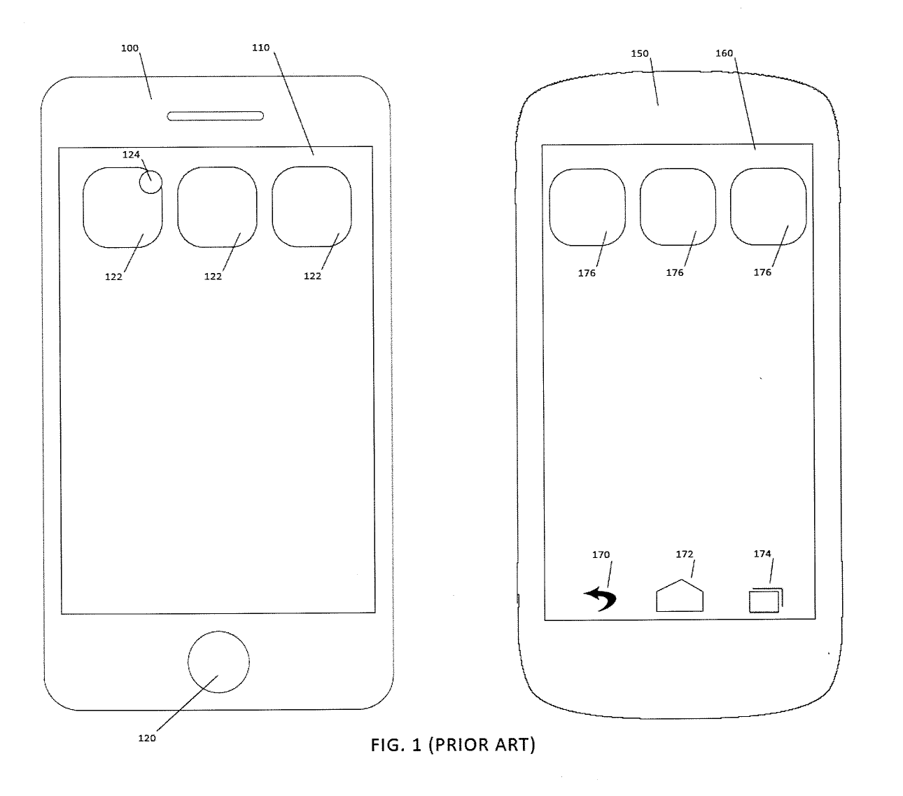

Referring to FIG. 1, depicted are two currently-existing electronic devices 100, 150 and components thereof. The devices 100, 150 respectfully include display screens 110, 160 for displaying content and functioning as user interfaces for receiving inputs and selections from a user. Further, the device 100 includes a home button 120 that allows a user to select basic device functionalities, such as activating the display screen 110, navigating to a home screen, and displaying a list of currently-executing applications. The home button 120 is a hardware button that is incorporated into a housing of the device 100. Particularly, the home button 120 can be physically depressed or actuated by the user to perform the corresponding function.

Similarly, the device 150 includes a set of virtual buttons 170, 172, 174 that can be selected by the user to perform corresponding functions. For example, the virtual button 170 corresponds to a “back” function, such as to return to a previous interface of the display screen 160, the virtual button 172 corresponds to a “home” function, such as to navigate to home screen, and the virtual button 174 corresponds to a “menu” function, such as to display a listing of recently-accessed applications. In contrast to the home button 120, the set of virtual buttons 170, 172, 174 are displayed on the display screen 160, and sense contact by a user via, for example, a capacitive sensor touch event. In other words, instead of having to physical depress a button, a user of the device 150 selects a corresponding virtual button 170, 172, 174 by making contact with a region corresponding to the display of the virtual button 170, 172, 174.

The display screens 110, 160 of the existing devices 100, 150 can also display icons 122, 176 associated with one or more applications of the devices 100, 150. For example, the applications can be communication applications (e.g., email, phone), utility applications, social networking applications, and the like. A user of the existing devices 100, 150 can select one of the icons 122, 176 to initiate the associated application. However, the user cannot initiate any of the associated applications using any of the home button 120 or the set of virtual buttons 170, 172, 174. Accordingly, the home button 120 and the set of virtual buttons 170, 172, 174 are limited to functions relating to navigating interface screens or performing basic functions, and a user of the exiting devices 100, 150 must make a separate selection of the icons 122, 176 to initiate applications of the devices 100, 150.

Further deficiencies exist in the button and icon implementations of the existing devices 100, 150. Particularly, neither the home button 120 nor the set of virtual buttons 170, 172, 174 can update with new information or with new selectable functions based on various interface screens or interactions. Indeed, the home button 120 is not displayed on a screen at all and the set of virtual buttons 170, 172, 174, while being “virtual,” have pre-set corresponding functions. Further, even though the set of virtual buttons 170, 172, 174 can “hide” when certain applications are initiated, the set of virtual buttons 170, 172, 174 still cannot modify their content or associated selectable functions. Further, the icons 122, 176 do not allow users to select various functions associated with the corresponding applications. Instead, selecting each icon 122, 176 merely initiates the corresponding application or returns the display screen to the previous interface of the already-executing application. Still further, a user is not allowed to toggle among various application identifiers from within a single icon 122, 176. Instead, each icon 122, 176 has a one-to-one correspondence with the corresponding application. In other words, the user is limited to initiating the application associated with the corresponding icon 122, 176. Moreover, the icons 122, 176 do not dynamically update with relevant information associated with notifications or communications received or detected by the corresponding application, or with selectable options to directly respond or access the notifications or communications. Instead, even though the icons 122, 176 can indicate a number of notifications (e.g., the “2” as indicated by 124), neither the indication 124 nor the icon 122 includes information describing the notification or selectable options to respond to the notification.

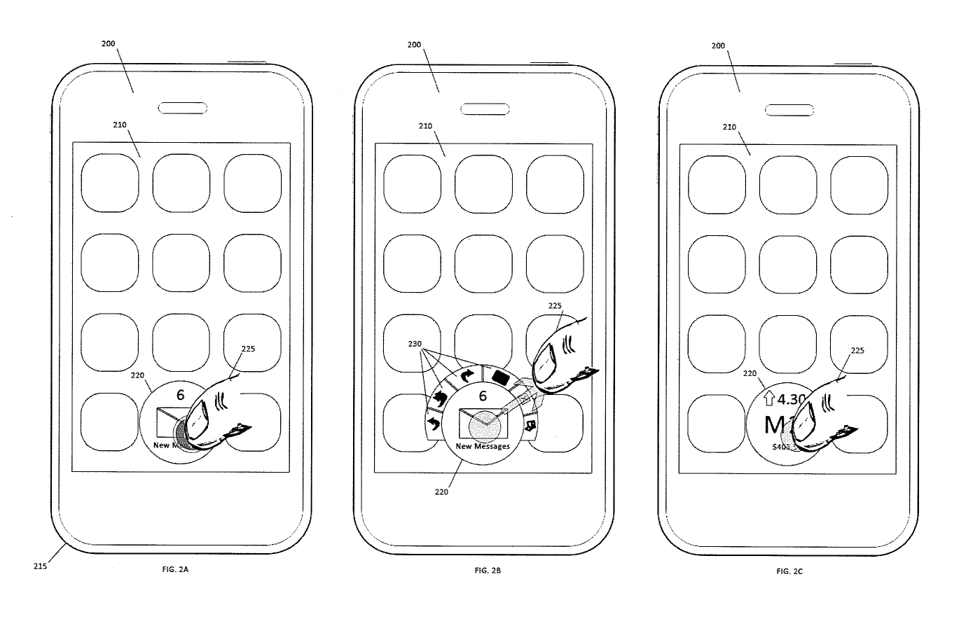

FIGS. 2A-2C depict an example electronic device 200 consistent with some embodiments. It should be appreciated that the electronic device 200 is merely an example and can include various combinations of hardware and/or software components.

As shown in FIGS. 2A-2C, the electronic device 200 can include a display screen 210 configured to display graphical information. Further, the display screen 210 can be a touchscreen capable of receiving inputs from a user of the electronic device 200. The electronic device 200 can further include a housing 215 that can be configured to support the display screen 210. The display screen 210 and the housing 215 can individually include one or more parts or components for supporting the display functions such as, for example, backlights, reflectors, and/or other components.

As shown in FIGS. 2A-2C, the display screen 210 can include an identification region 220 that can be configured to display information, icons or graphics, notifications, and any other type of visual data. According to embodiments, the identification region 220 can automatically or manually display information or data associated with applications of the electronic device 200 such as, for example, messaging or communication applications, social networking applications, Internet applications, utility applications (e.g., calculator, calendar, weather, etc.), and/or other types of applications. For example, the identification region 220 as shown in FIG. 2A includes information that indicates the existence of six (6) new messages associated with an email application. The identification region 220 can be configured to change, modify, or otherwise update based on various indications, selections, and the like. In embodiments, the identification region 220 can initially be hidden, and can activate or display upon the electronic device detecting various notifications, user interactions, or the like, or upon the expiration of a predetermined time period. For example, a user can activate the identification region 220 by swiping his or her finger across the display screen 210. Similarly, the electronic device 200 can cause the identification region 220 to hide or otherwise deactivate upon detecting other various notifications, user interactions, or the like, or upon the expiration of a predetermined time period.

According to embodiments, the display screen 210 can detect a selection, by a user, of the identification region 220. For example, as shown in FIG. 2A, a user's finger 225 can make contact with the display screen 210 to select the identification region 220. In response to the user selecting the identification region 220, the electronic device 200 can identify a set of functions associated with the application that corresponds to the information displayed in the identification region 220. For example, for an email application, the set of functions can include a new email function, a reply function, a delete function, an inbox selection function, and others. For further example, for a phone application, the set of functions can include a keypad function, a missed calls function, a call history function, and a contacts function.

The display screen 210 can display indications of the set of functions in a proximity to the identification region 220. For example, as shown in FIG. 2B, the display screen 210 displays indications 230 of the set of functions associated with an email application in a semi-circle around the identification region 220. It should be appreciated that various placements, orderings, layouts, and the like for the indications are envisioned. In some cases, the display screen 210 can display the indications 230 in response to a user selecting the identification region 220 or in response to the user maintaining contact with the identification region 220 for a predetermined amount of time.

The user can select any of the indications 230 via various gestures or interactions with the display screen 210. In some cases, the user can perform a “swipe” gesture wherein the user selects the identification region 220, maintains contact with the display screen 210, “swipes” outward to one of the indications 230, and releases the contact with the display screen 210, wherein the indication 230 corresponding to the location where the user releases contact is the selected indication. In other cases, the user can individually select the identification region 220 followed by selecting the desired indication 230. It should be appreciated that other gestures or interactions with the display screen 210 to select a desired indication 230 are envisioned.

In response to the user selecting the desired indication 230, the electronic device 200 can initiate the application corresponding to the information of the identification region 220. Particularly, the application can initiate according to the function associated with the selected indication 230. For example, if a user selects a “new email” indication of an email application, then the electronic device 200 can initiate the email application and display, on the display screen 210, an interface screen that allows a user to create a new email. For further example, if a user selects a “friend requests” indication of a social networking application, then the electronic device 200 can initiate the social networking application and display, on the display screen 210, an interface screen that displays any friend requests that the user has received. Further, for example, if a user selects a “keypad” indication of a phone application, then the electronic device 200 can initiate the phone application and display, on the display screen 210, an interface screen that allows the user to enter a phone number for the phone application to dial. Once the electronic device 200 initiates the application, the user can navigate through the various functions and interfaces of the application via the display screen 210. Further, in some cases, once the electronic device 200 initiates the application, the identification region 220 and/or any of the indications 330 can modify to display information or indicate functions associated with the execution of the application.

In some embodiments, the identification region 220 can display additional or secondary information in response to the display screen 210 detecting a selection of the identification region 220 by the user 225. Advantageously, a user is able to gauge or view the additional or secondary information without having to initiate any applications or perform other gestures with the display screen 210. For example, as shown in FIG. 2C, if the application corresponding to the information in the identification region 220 is a stock application, then the identification region 220 can modify to display specific stock quotes and other associated information.

The display screen 210 can display the additional or secondary information in response to detecting various gestures by the user. In some cases, the display screen 210 can display the additional or secondary information in response to detecting user contact with the identification region 220 for a predetermined amount of time. In other cases, the display screen 210 can display the additional or secondary information in response to detecting a “tap” gesture where the user briefly contacts the identification region 220. The display screen can further identify functions associated with the application and display indications of the functions, as described herein, in response to the user selecting the identification 220 when it is populated with the additional or secondary information.

According to embodiments, the identification region 220 can dynamically change, modify, or vary the displayed information such that various applications are represented by the displayed information. More particularly, instead of the various static regions of the display screen 210 being associated with various corresponding applications, varying the displayed information can rotate or toggle which corresponding applications are “active” within the identification region 220. For example, the electronic device 200 can display information in the identification region 220 that corresponds to a text messaging application, and can then modify the identification region 220 to display information that corresponds to a phone application.

In embodiments, the updating of the information in the identification region 220 can be in response to detecting one or more indications. In some cases, the identification region 220 can update the information in response to the display screen 210 detecting a selection of the identification region 220 by a user. More particularly, the identification region 220 can rotate the information if the user “taps” the identification region 220 or otherwise does not maintain contact with the display screen 210 for a predetermined amount of time. In other cases, the identification region 220 can update the information on a periodic basis, for example by rotating the information after a predetermined amount of time. It should be appreciated that the predetermined amounts of time associated with these functionalities can be default values or configured by a user of the electronic device 200.

In still other cases, the identification region 220 can update the information in response to the electronic device 200 receiving or detecting a communication or notification, either locally or via a network connection. For example, if the electronic device 200 receives an incoming phone call, the electronic device 200 can modify the identification region 220 to indicate the incoming call and display one or more selectable options to respond to the incoming call. If the user selects one of the selectable options, the electronic device 200 can initiate a corresponding phone application according to the selected option. For further example, if a music application finishes playing a song, the electronic device 200 can modify the identification region 220 to indicate the completed song, identify a subsequent song, or display other information associated with the music application, and display one or more selectable options for the music application. If the user selects one of the selectable options, the electronic device 200 can initiate the music application according to the selected option.

In further cases, the identification region 220 can update the information in response to the electronic device 200 being in a proximity to a physical object, such as a business, individual, automobile, and/or other object. More particularly, the electronic device 200 can identify its location, such as via a Global Positioning System (GPS) chip embedded therein, and determine that it is located in a proximity to coordinates or an address associated with the physical object. In other cases, the electronic device can detect the presence of the physical object via an established communication such as, for example, a near field communication (NFC), contactless smart chip, a Bluetooth® network, a wireless local area network (WLAN), or other communication channels or networks, or other sensing or communication devices or components. More particularly, the electronic device 200 and the physical object can each be configured with sensing components that can automatically detect the presence of the other device or object.

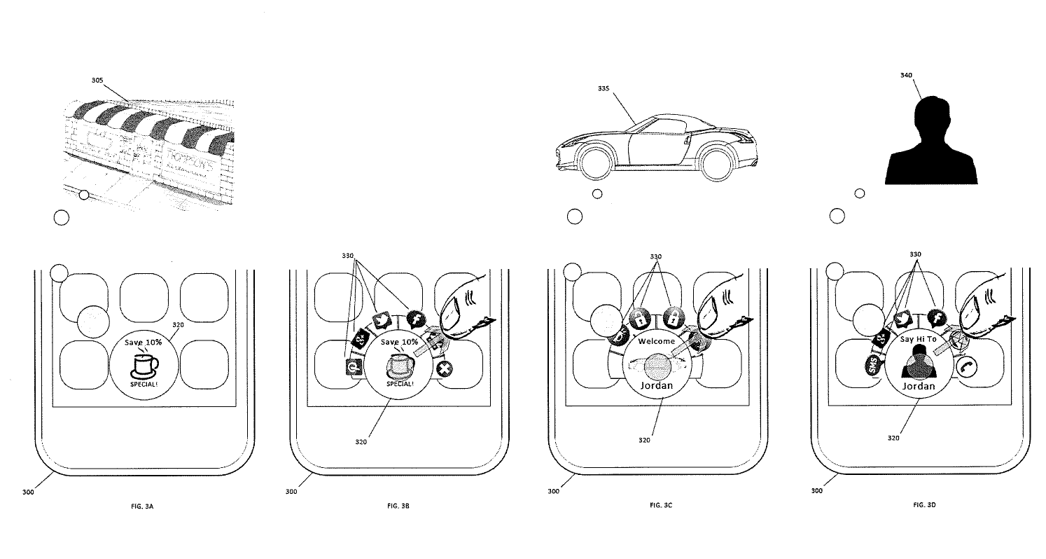

For example, referring to FIG. 3A, an electronic device 300 can determine that it is in proximity to a store 305, can identify an offer related to the store 305, and can modify whatever is displayed in an identification region 320 to display the offer within the identification region 320. Further, in response to a user selecting the offer within the identification region 320, the electronic device 300 can determine a set of functions associated with the offer and display indications 330 of the set of functions in a proximity to the identification region 320. For example, as shown in FIG. 3B, the indications 330 of the set of functions can correspond to “sharing” functionalities of various social networking services including Pinterest®, Google+®, Twitter®, and Facebook®. In some cases, the electronic device 300 can display the indications 330 without the user selecting the identification region 320.

Another example is illustrated in FIG. 3C, whereby the electronic device 300 determines that it is in proximity to a vehicle 335. In some cases, the electronic device 300 and the vehicle 335 can be equipped with components that implement a communication protocol, such as NFC. Particularly, the electronic device 300 or the vehicle 335 can be equipped with a powered NFC chip, and the other of the electronic device 300 or the vehicle 335 can be equipped with an unpowered NFC chip (“tag”) such that electronic device 300 can detect the presence of the vehicle 335, or vice-versa, when the electronic device 300 is within a range or proximity of the vehicle 335. In embodiments, both the electronic device 300 and the vehicle 335 can be equipped with powered NFC chips. The presence detection can occur either manually or automatically. In other cases, the electronic device 300 can determine its location and compare the location to that of the vehicle 335 to determine that the electronic device 300 is in proximity to the vehicle 335.

In response to the presence detection or the proximity determination, the electronic device 300 can display an indication of the automobile 335 in the identification region 320. Further, if the user selects the automobile indication within the identification region 320, the electronic device 300 can determine a set of functions associated with an automobile application and display indications 330 of the set of functions in a proximity to the identification region 320. For example, as shown in FIG. 3C, the indications 330 of the set of functions can correspond to options to lock or unlock the automobile 335, sound a horn, or open the trunk. In some cases, the electronic device 300 can display the indications 330 without the user selecting the identification region 320.

A further example is illustrated in FIG. 3D, whereby the electronic device 300 determines that it is in proximity to an individual 340. In some cases, the electronic device 300 and a device of the individual 340 can be equipped with components that implement a communication protocol, such as NFC. Particularly, the electronic device 300 or the device of the individual 340 can be equipped with a powered NFC chip, and the other of the electronic device 300 or the device of the individual 340 can be equipped with an unpowered NFC chip (“tag”) such that electronic device 300 can detect the presence of the device of the individual 340, or vice-versa, when the electronic device 300 is within a range or proximity of the device of the individual 340. In embodiments, both the electronic device 300 and the device of the individual 340 can be equipped with powered NFC chips. The presence detection can occur either manually or automatically. In other cases, the electronic device 300 can determine its location and compare the location to that of the device of the individual 340 to determine that the electronic device 300 is in proximity to the device of the individual 340.

In response to the presence detection or the proximity determination, the electronic device 300 can display an indication of the individual 340 in the identification region 320. Further, if the user selects the identification region 320, the electronic device 300 can determine a set of functions associated with communicating with the individual 340 and display indications 330 of the set of functions in a proximity to the identification region 320. For example, as shown in FIG. 3D, the indications 330 of the set of functions can correspond to communication channels such as, for example, text messaging (SMS), emailing, calling, interacting via social networks, and/or others. In embodiments, the electronic device 300 can determine the indications 330 based on contact information of the individual 340, any social network “connections” between the user and the individual 340, or other information. In some cases, the electronic device 300 can display the indications 330 without the user selecting the identification region 320.

In each of the use cases as depicted in FIGS. 3B-3D, the user can select one of the indications 330 to perform the function of the selected indication 330. For example, as shown in FIG. 3B, the user can select to share the offer displayed in the information region 320 with his or her followers on Twitter® by selecting the corresponding Twitter® indication. For further example, as shown in FIG. 3C, the user can select the unlock indication to unlock the vehicle 335, which can cause the electronic device 300 to send an unlock request to the vehicle 335. Further, for example, as shown in FIG. 3D, the user can select the text message (SMS) indication to initiate a text messaging application interface that allows the user of the electronic device 300 to send a text message to the device of the individual 340. The user can select the corresponding indication 330 using a “tap-hold-swipe-release” gesture or other gestures, as described herein or as envisioned. In some cases, the selection of the corresponding indication 330 can be detected by various hardware components of the electronic device 300 such as, for example, an accelerometer. It should be appreciated that various functions and combinations of functions associated with the information in the identification region 320 and the indications 330 are envisioned. In some embodiments, if the user does not select the identification region 320, the electronic device 300 can modify the identification region 320 to display information associated with another application of the electronic device 300. Further, one of the indications 330 (e.g., an “X”) can allow the user to update the display of the identification region 320 to indicate other applications.

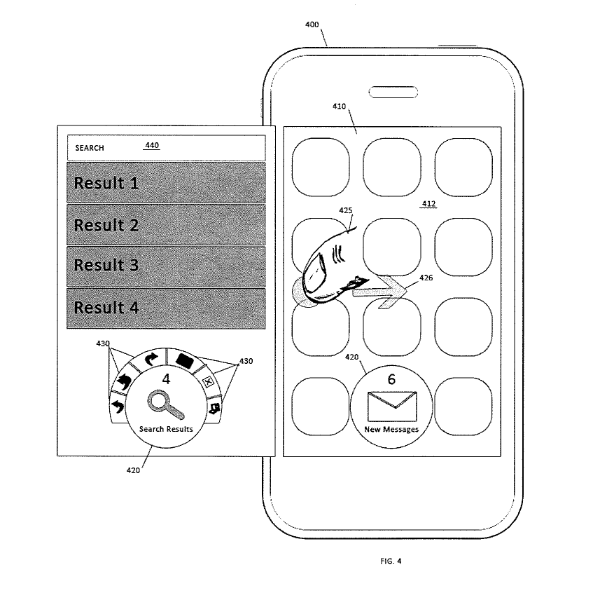

FIG. 4 depicts an example electronic device 400 consistent with some embodiments. In particular, FIG. 4 depicts functionality relating to managing content associated with an identification region.

A display screen 410 of the electronic device 400 can include an identification region 420 that displays an indication of an email application with a notification of unread messages. It should be appreciated that the identification region 420 is capable of the functionalities as discussed herein such as, for example, displaying indications of other applications, receiving selections from a user, displaying secondary information, and others. Further, the display screen 410 can initially display a first interface screen 412 that can include icons associated with applications, the identification region 420, and/or other regions, indications, or combinations thereof.

According to embodiments, a user 425 can select the display screen 410 and perform a “swipe” gesture in the direction of an arrow 426. The swipe gesture can serve to “switch” interface screens displayed on the display screen 410. More particularly, when the user performs the swipe gesture, the display screen 410 can replace the first interface screen 412 with a second interface screen 440 that also includes the identification region 420. Further, when the display screen 410 replaces the first interface screen 412 with the second interface screen 440, the corresponding application or function indicated by the identification region 420 can change. For example, as shown in FIG. 4, when the second interface screen 440 displays on the display screen 410, the identification region 420 indicates a search application. In embodiments, the first interface screen 412 and the second interface screen 440 can be associated with a main interface of the electronic device whereby the display screen 410 does not display any indications of currently-executing applications. In some cases, when the display screen 410 switches from the first interface screen 412 to the second interface screen 440, an application corresponding to the second interface screen 440 can initiate and associated functions can display in the second interface screen 440. For example, as shown in FIG. 4, the second interface screen 440 includes a search box and a result list.

In embodiments, the identification region 420 can further display indications 430 of a set of functions associated with the application. Particularly, the identification region 420 can display the indications 430 in response to detecting a user selection, as discussed herein. As shown in FIG. 4, the indications 430 can include navigation arrows for selecting various results, an indication to cancel the search, and/or others. The user can select any of the indications 430 according to the gestures and techniques as discussed herein including, for example, swipe to activate, multiple selections, and others. It should be appreciated that the interface screens 412 440 and the information of the information region 420 are merely exemplary and embodiments contemplate various types and combinations of interface screens and information.

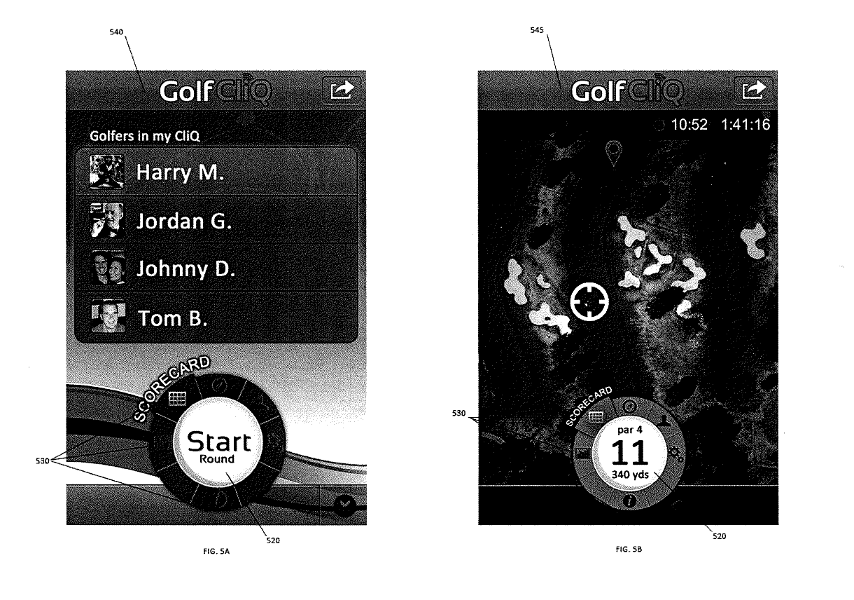

Referring to FIGS. 5A and 5B, depicted are exemplary interface screens that can be displayed on a display screen and are associated with an application executing on an electronic device. For example, the application depicted in FIGS. 5A and 5B is “GolfCliQ,” however it should be appreciated that the functionalities as discussed herein can be applied to any application capable of being executed on the electronic device.

As shown in FIG. 5A, the application has an associated first interface screen 540 in which various selectable functions, information, or other data can be displayed. The application can also display an identification region 520 overlaying the first interface screen 540. In embodiments, the identification region 520 can include information and/or selectable functions that correspond to the first interface screen 540. For example, the first interface screen 540 of the GolfCliQ application includes a listing of golfers and the identification region 520 includes selectable options associated with the first interface screen 540, namely, options to start the round, select a scorecard, and others.

Throughout the execution or navigation of the application, the interface screen displayed on the display screen of the electronic device can change. Referring to FIG. 5B, depicted is a second interface screen 545 associated with the GolfCliQ application. Particularly, the second interface screen 545 depicts functionality related to supplying information to a group of users playing a golf course. As shown, the identification region 520 includes information such as hole number, yardage, and par. Further, the identification region 520 includes indications 530 of a set of functions associated with the identification region 520. For example, the indications 530 associated with the second interface screen 545 include a scorecard function, a navigation function, a social function, a settings function, a charts function, and an information function. According to embodiments, the information in the identification region 520 can dynamically update based on the current interface screen of the application, as well as other factors. In some cases, the information in the identification region 520 can update based on a user location, for example, if the electronic device detects that the user is playing a different hole or detects that the user is approaching a specific part of a golf hole (e.g., bunker, green, etc.).

According to embodiments, the information in the identification region 520, as well as the indications 530 of a set of functions associated with the identification region 520, can update based on switches among underlying interface screens. Particularly, the interface screens can change if the application enters a different mode or operating state (e.g., setup, game play, round review, etc.), or the interface screens can change within the same mode or operating state. For example, if the application switches from the first interface screen 540 (corresponding to a setup mode) to the second interface screen 545 (corresponding to a game play mode), then the information and set of indications 530 associated with the identification region 520 can change to indicate information and functions associated with the second interface screen 545. For further example, if the second interface screen 545 switches to an additional interface screen associated with a game play mode, such as if the application detects that the user has reach the green of a particular hole, then the identification region 520 can update with updated information and/or a new set of indications 530 associated with the additional interface screen. In embodiments, the dynamic modification of the information region 520 can occur with or without user input. Further, the user can select any of the indications 530 according to the gestures and techniques as discussed herein including, for example, swipe to activate, multiple selections, and others.

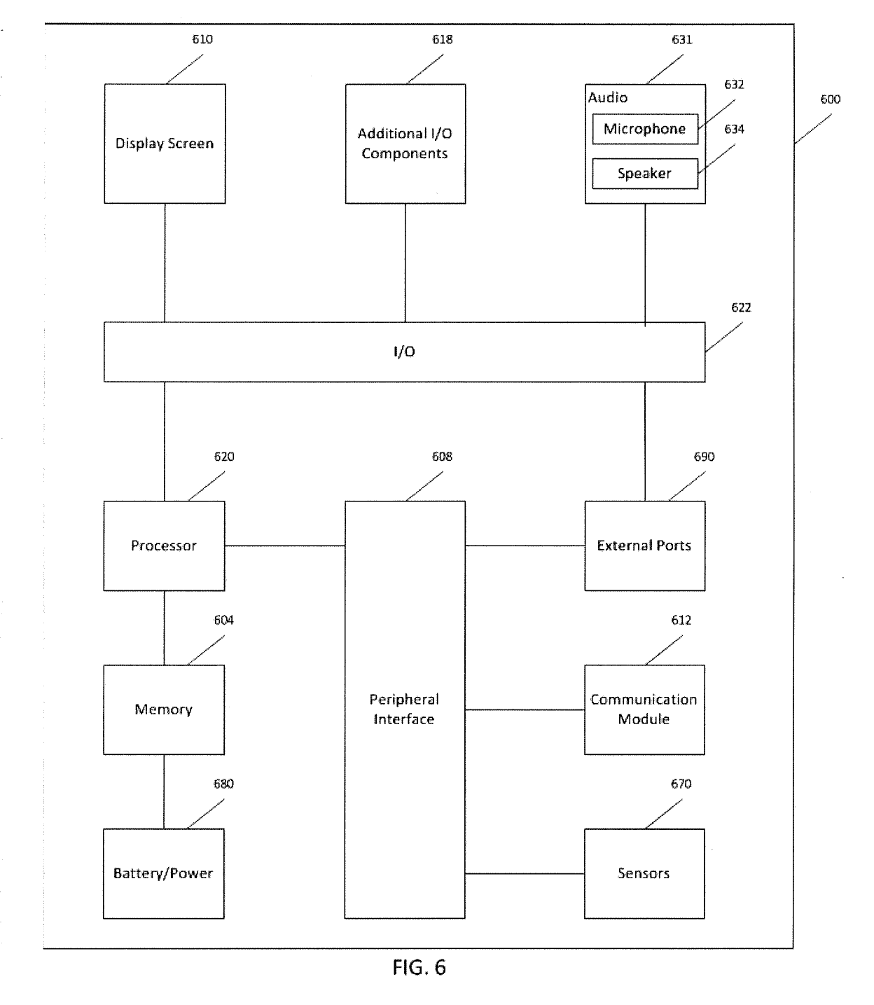

FIG. 6 illustrates an example electronic device 600 in which the embodiments may be implemented. The electronic device 600 can include a processor 620, memory 604 (e.g., hard drives, flash memory, MicroSD cards, and others), a power module 680 (e.g., batteries, wired or wireless charging circuits, etc.), a peripheral interface 608, and one or more external ports 690 (e.g., Universal Serial Bus (USB), HDMI, Firewire, and/or others). The electronic device 600 can further include a communication module 612 configured to interface with the one or more external ports 690. For example, the communication module 612 can include one or more transceivers functioning in accordance with IEEE standards, 3GPP standards, or other standards, and configured to receive and transmit data via the one or more external ports 690. More particularly, the communication module 612 can include one or more WWAN transceivers configured to communicate with a wide area network including one or more cell sites or base stations to communicatively connect the electronic device 600 to additional devices or components. Further, the communication module 612 can include one or more WLAN and/or WPAN transceivers configured to connect the electronic device 600 to local area networks and/or personal area networks, such as a Bluetooth® network.

The electronic device 600 can further include one or more sensors 670 such as, for example, GPS sensors, NFC sensors or tags, accelerometers, gyroscopic sensors (e.g., three angular-axis sensors), proximity sensors (e.g., light detecting sensors, or infrared receivers or transceivers), touch sensors, and/or other sensors; and an audio module 631 including hardware components such as a speaker 634 for outputting audio and a microphone 632 for receiving audio. The electronic device 600 further includes an input/output (I/O) controller 622, a display screen 610, and additional I/O components 618 (e.g., capacitors, keys, buttons, lights, LEDs, cursor control devices, haptic devices, and others). The display screen 610 and the additional I/O components 618 may be considered to form portions of a user interface (e.g., portions of the electronic device 600 associated with presenting information to the user and/or receiving inputs from the user).

In embodiments, the display screen 610 is a touchscreen display using singular or combinations of display technologies such as electrophoretic displays, electronic paper, polyLED displays, OLED displays, AMOLED displays, liquid crystal displays, electrowetting displays, rotating ball displays, segmented displays, direct drive displays, passive-matrix displays, active-matrix displays, and/or others. Further, the display screen 610 can include a thin, transparent touch sensor component superimposed upon a display section that is viewable by a user. For example, such displays include touchscreen technologies such as resistive panels, surface acoustic wave (SAW) technology, capacitive sensing (including surface capacitance, projected capacitance, mutual capacitance, and self-capacitance), infrared, optical imaging, dispersive signal technology, acoustic pulse recognition, and/or others.

The display screen 610 can be configured to interact with various manipulators, such as a human finger or hand. Each type of manipulator, when brought into contact with the display screen 610, can cause the display screen 610 to produce a signal that can be received and interpreted as a touch event by the processor 620. The processor 620 is configured to determine the location of the contact on the surface of the display screen 610, as well as other selected attributes of the touch event (e.g., movement of the manipulator(s) across the surface of the screen, directions and velocities of such movement, touch pressure, touch duration, and others).

The display screen 610 or one of the additional I/O components 618 can also provide haptic feedback to the user (e.g., a clicking response or keypress feel) in response to a touch event. The display screen 610 can have any suitable rectilinear or curvilinear shape, however embodiments comprehend any range of shapes, sizes, and orientations for the display screen 610. In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 620 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

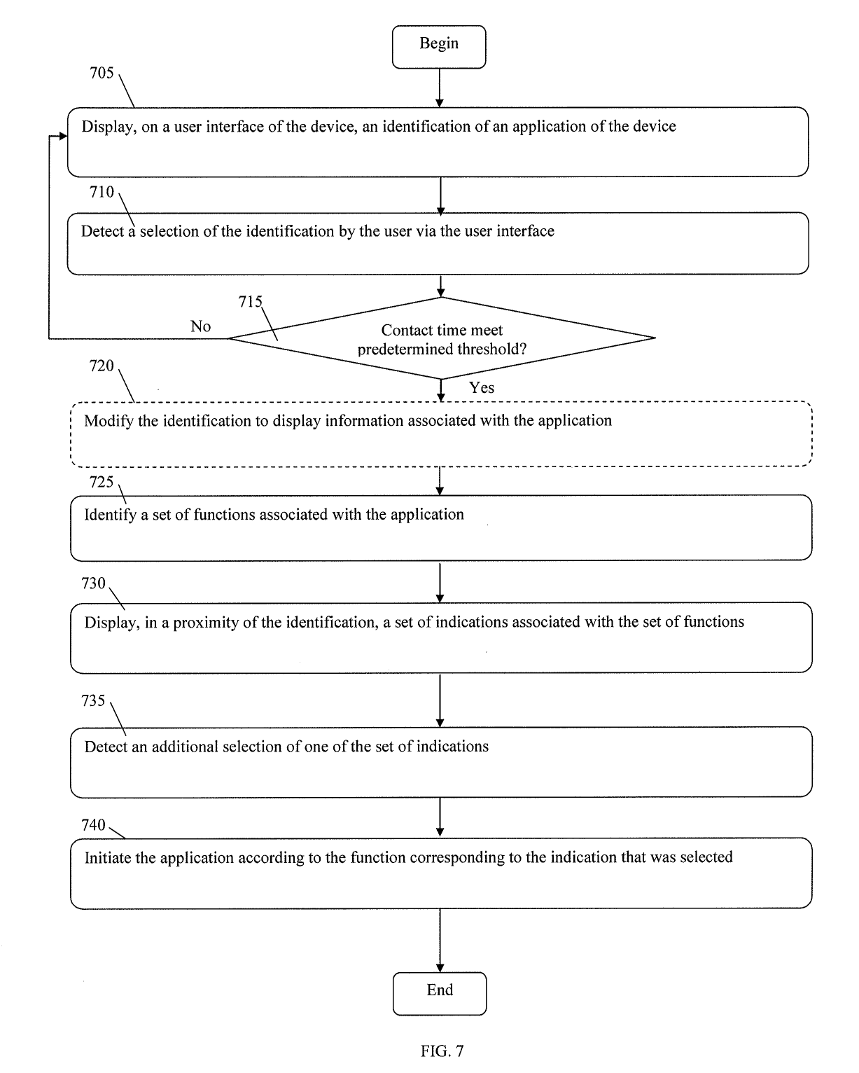

FIG. 7 is a flowchart of a method 700 for a device (such as the electronic device 200 as shown in FIG. 2) to facilitate application initiation via a dynamic identification region. More particularly, the method 700 relates to the device displaying various indications of functions associated with applications in response to user selections.

The method 700 begins with the device displaying 705, on a user interface, an identification of an application of the device. The identification can include information associated with the application such as, for example, textual information, icons or graphics, notifications, and any other type of visual data. The device detects 710 a selection of the identification by the user via the user interface. In embodiments, the selection can be a touch event on a display screen via a user's finger, a stylus, or another actuating component. The device determines 715 whether a contact time of the selection meets a predetermined threshold. For example, the predetermined threshold can be a half of a second, a second, or other time periods. If the contact time does not meet the predetermined threshold, then processing can return to 705. In some cases, the device can display an identification of a second application of the device if the contact time does not meet the predetermined threshold.

In contrast, if the contact time does meet the predetermined threshold, then the device optionally modifies 720 the identification to display information associated with the application, such as various types of secondary information. For example, if the application is a weather application, then the displayed information can include current conditions, various forecasts, radar maps, and/or other textual or graphical information. The device identifies 725 a set of functions associated with the application. In some cases, the functions can correspond to various operations executable by the application. For example, the functions for an email application can be “Create Email,” “Delete,” “Inbox,” “Contacts,” and others. In other cases, the functions can correspond to operations executable by another application via the application. More particularly, the applications can be linked such that they can exchange data with each other when the appropriate application is selected and/or executed.

The device displays 730, in a proximity of the identification, a set of indications associated with the set of functions. In embodiments, the indications can be any textual or graphical information, such as icons, that can display on the user interface. The proximity can be adjacent or close to adjacent to the identification. Further, the set of indications can be arranged in various shapes or alignments. For example, the set of indications can be arranged in a circle or semi-circle around the identification, such as shown in FIG. 2B.

The device detects 735 an additional selection of one of the set of indications. According to embodiments, the additional selection can be detected via various gestures. For example, the user can “swipe” from the area defined by the identification to the area defined by the selected indication and release contact at that point. For further example, the user can make a first explicit selection of the identification, release his or her contact with the display screen, and make a second explicit selection of the selected indication. In some cases, if the user releases his or her contact with the display screen, then the display screen can remove the set of indications from displaying on the user interface, and processing can return to 705 wherein the device can detect further selections of the identification.

After the additional selection is detected, the device initiates 740 the application according to the function corresponding to the indication that was selected. For example, if the application is a phone application and the selected indication corresponds to a “missed calls” function, then the device initiates the phone application and displays the appropriate interface for missed calls. For further example, if the application is a social networking application and the selected indication corresponds to a “my profile” function, then the device initiates the social networking application and displays the appropriate profile interface. In embodiments, after the device initiates the application, the device can modify the original identification to display information and indications of functions associated with the initiated application.

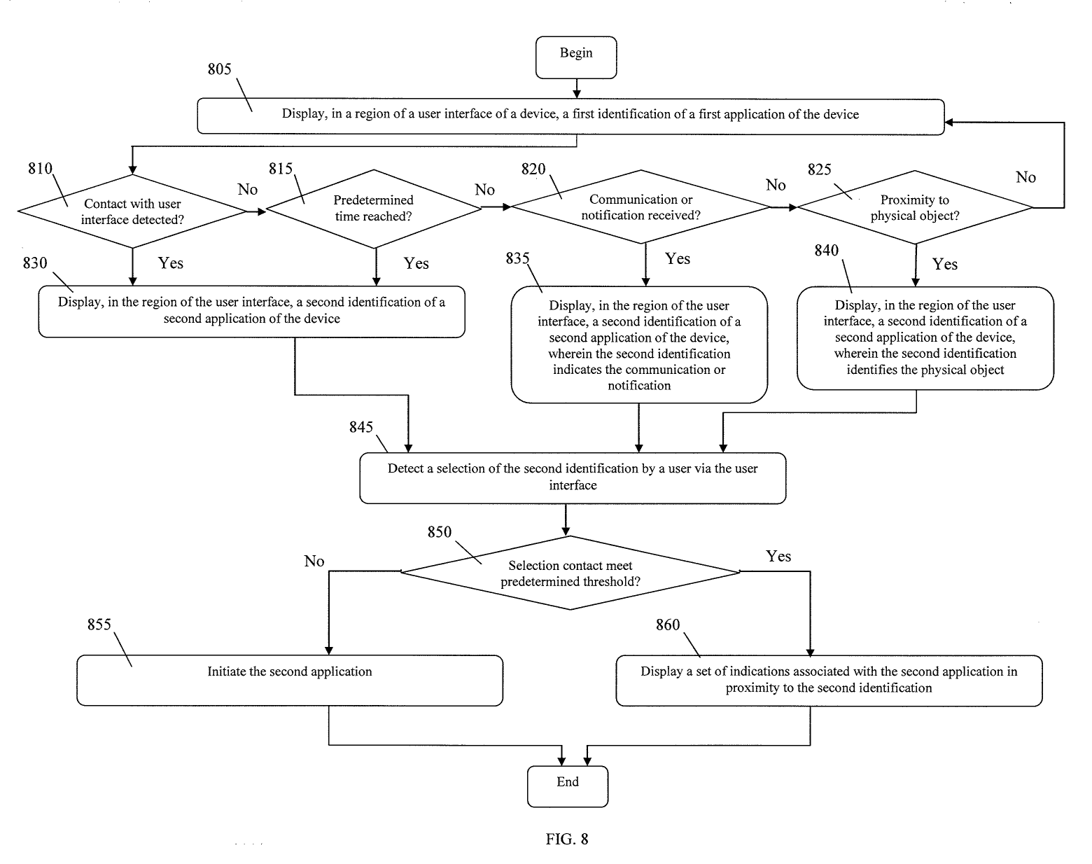

FIG. 8 is a flowchart of a method 800 for a device (such as the electronic device 200 as shown in FIG. 2) to dynamically modify an identification region of the device. More particularly, the method 800 relates to the device displaying multiple identifications of multiple applications within a “soft” key of a user interface.

The method 800 begins with the device displaying 805, in a region of a user interface, a first identification of a first application of the device. The first identification can include information associated with the first application such as, for example, textual information, icons or graphics, notifications, and any other type of visual data. The device can detect various indications to display a second identification of a second application of the device. For instance, as shown in FIG. 8, the device can detect 810 if contact with the user interface has been made, such as a touch event on a display screen via a user's finger, a stylus, or another actuating component. Further, the device can determine 815 if a predetermined time limit has been reached. The predetermined time limit can be any amount, for example two seconds, ten seconds, or other values. The device can further determine 820 if a communication or notification has been received. In embodiments, the communication can be a phone call, text message, or other type of communication that can be received by the device via a data communication network, such as any network as discussed herein, and the notification can be any event or data associated with an execution of an application. For example, if the application is a music player, the notification can be generated in response to a song finishing, the start of a new song or playlist, or other similar functions or triggers.

The device can also determine 825 if the device is located in proximity to a physical object such as, for example, a business, an automobile, an individual, or other objects. In some cases, the device can identify its location and compare the location to stored locations of physical objects, such as an address in a database. In other cases, the device can detect a presence of the physical object via communication components such as, for example, near field communication components. It should be appreciated that other indication detection techniques are envisioned, such as a switch from a first interface screen of a “home” or “main” screen to a second interface screen of the “home” or “main” screen, or others.

If contact with the user interface is detected or the predetermined time limit is reached, then the device displays 830, in the region of the user interface, the second identification of the second application. If a communication or notification is received, the device displays 835 the second identification in the region, wherein the second identification indicates the communication or the notification. Optionally, the second identification can include a selectable option to respond to the communication or the notification. If the location of the device is in proximity to the physical object, the device displays 840 the second identification in the region, wherein the second identification identifies the physical object.

The device detects 845 a selection of the second identification by the user via the user interface. It should be appreciated that the selection can be detected via various gestures or selection techniques, such as a “swipe,” multiple selections, and/or others. In cases in which the communication or the notification is received, the device can automatically initiate an appropriate response functionality. The device determines 850 if the contact time for the selection meets or exceeds a predetermined threshold. For example, the predetermined threshold can be a half of a second, a second, or other time periods. If the contact time does not meet the predetermined threshold, then the device initiates 855 the second application.

In contrast, if the contact time meets the predetermined threshold, then the device can identify a set of functions associated with the second application and display 860 a set of indications associated with the functions in proximity to the second identification. For example, the set of indications can be displayed adjacent to or near the second identification, and can be displayed in various arrangements, such as in a semi-circle. The device can also detect a selection of one of the indications, as described herein with respect to FIG. 7.

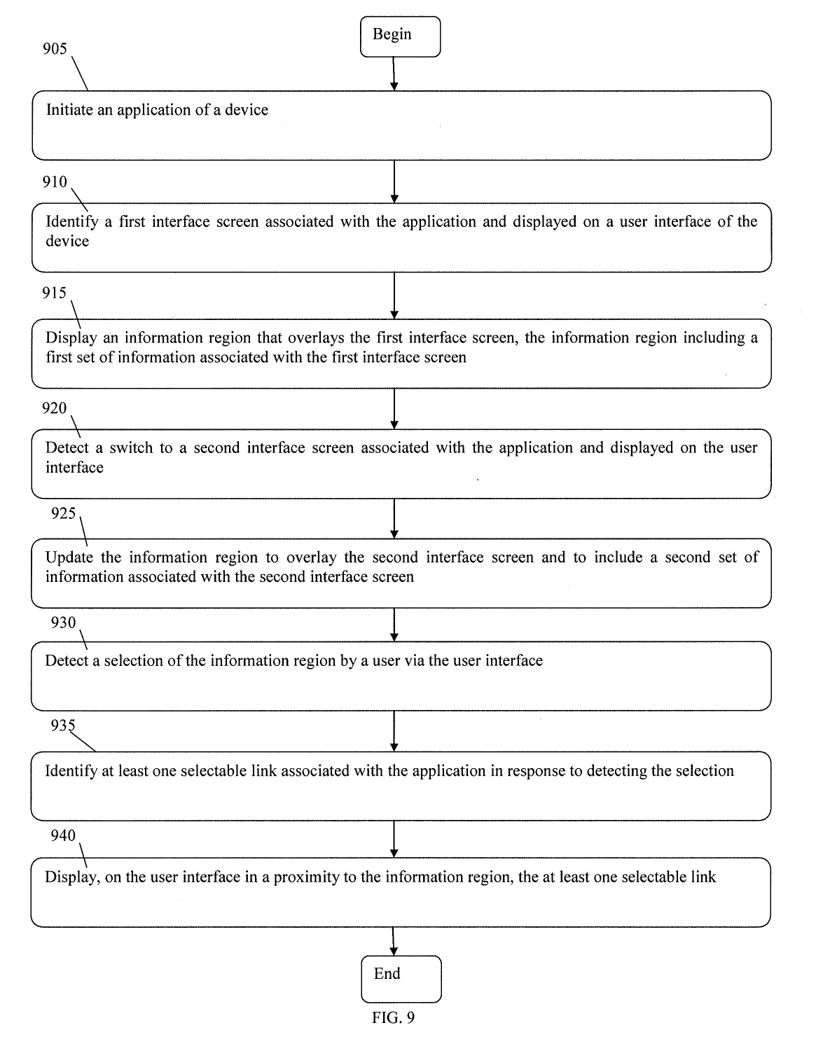

FIG. 9 is a flowchart of a method 900 for a device (such as the electronic device 200 as shown in FIG. 2) to dynamically modify an identification region of the device. More particularly, the method 900 relates to the device modifying a “soft” identification region within an application in response to interface screens of the application changing.

The method 900 begins with the device initiating 905 an application of the device. The device identifies 910 a first interface screen associated with the application and displayed on a user interface of the device. For example, if the application is an interactive golf application, as described herein, the first interface screen can correspond to a first golf hole. The device displays 915 an information region that overlays the first interface screen, the information region including a first set of information associated with the first interface screen. In embodiments, the first set of information can include textual information, icons or graphics, notifications, and any other type of visual data, and can be based on the location of the device and/or other parameters. For example, using the golf application example, the first set of information can include an indication of the hole number, the yardage of the hole, the par of the hole, and other information. It should be appreciated that the information region can overlay the first interface screen at any position or region.

The device detects 920 a switch to a second interface screen associated with the application and displayed on the user interface. More particularly, the application can replace the display of the first interface screen with the display of the second interface screen. For example, the second interface screen can be associated with a second golf hole. The device updates 925 the information region to overlay the second interface screen and to include a second set of information associated with the second interface screen. More particularly, the device can dynamically replace the first set of information with the second set of information in response to the interface screen changing. For example, in the golf application, the information region can update to include information about the second golf hole instead of the first golf hole.

The device detects 930 a selection of the information region by a user via the user interface. The selection can be detected via any type of touch event, gesture, or the like. The device identifies 935 at least one selectable link associated with the application in response to detecting the selection. Referring back to the golf application example, the selectable links can be a scorecard, a settings option, an information link, and/or others. The device displays 940, on the user interface in a proximity to the information region, the at least one selectable link. A user can select the selectable link via any type of gesture or interaction with the user interface, as discussed herein.

Thus, it should be clear from the preceding disclosure that the systems and methods allow for an effective and efficient navigation of device applications and functionalities. The systems and methods advantageously allow a user of an electronic device to select applications and functionalities thereof via a single identification region. Further, the systems and methods dynamically update the information region to display information, notifications, and communications associated with various applications.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-6. (canceled)

7. A method in an electronic device, the method comprising:
displaying, in an informational region of a user interface of the device, a first identification of a first application of the device, the informational region overlaying at least a portion of an interface screen associated with the user interface;
detecting, by a processor, an indication to display a second identification of a second application of the device; and
in response to the detecting the indication, displaying the second identification in the informational region of the user interface in place of the first identification in the location of the first indication;
detecting a selection of the second identification by a user via the user interface;
identifying a set of functions associated with the second application in response to the detecting the selection; and
displaying, in the informational region of the user interface, a set of indications associated with the set of functions, the set of indications being displayed around the second identification.

8. The method of claim 7, wherein the detecting the indication to display the second identification comprises:
detecting a contact by the user with the user interface in the informational region in which the first identification is displayed.

9. The method of claim 7, wherein the detecting the indication to display the second identification comprises:
determining that the first identification is displayed for a predetermined amount of time.

10. The method of claim 7, wherein the detecting the indication to display the second identification comprises:
receiving a communication associated with the second application, wherein the second identification comprises a notification of the communication and a selectable option to respond to the communication.

11. The method of claim 7, wherein the detecting the indication to display the second identification comprises:
detecting a notification associated with the second application, wherein the second identification indicates the notification.

12. A method in an electronic device, the method comprising:
displaying, in an informational region of a user interface of the device, a first identification of a first application of the device, the informational region overlaying at least a portion of a first interface screen of the user interface;
detecting, by a processor, an indication to display a second identification of a second application of the device, the detecting the indication including detecting a switch from a first interface screen to a second interface screen, wherein the first interface screen and the second interface screen are associated with a main interface of the electronic device; and
in response to the detecting the indication, displaying the second identification in the informational region of the user interface in place of the first identification in the location of the first identification, the informational region overlaying at least a portion of the second interface screen after the switch from the first interface screen to the second interface screen, wherein a position of the informational region relative to the user interface remains consistent in the switch from the first interface screen to the second interface screen.

13. The method of claim 7, wherein the detecting the indication to display the second identification comprises:
identifying a location of the device; and
determining that the location of the device is in proximity to a physical object, wherein the second identification comprises information identifying the physical object.

14. The method of claim 13, wherein if the physical object is a business, the method further comprises:
detecting a selection of the second identification by a user via the user interface, wherein the second indication displays an offer associated with the business.

15. A method in an electronic device, the method comprising:
displaying, in an informational region of a user interface of the device, a first identification of a first application of the device, the informational region overlaying at least a portion of an interface screen of the user interface;
detecting, by a processor, an indication to display a second identification of a second application of the device, the detecting the indication including detecting, via a communication, a presence of a physical object in proximity to the device, wherein the second identification comprises information identifying the physical object; and
in response to the detecting the indication, displaying the second identification in the informational region of the user interface in place of the first identification in the location of the first indication.

16. The method of claim 14, further comprising:
detecting a selection of the second identification by a user via the user interface; identifying a set of functions associated with the second application in response to the detecting the selection; and
displaying, on in the informational region of the user a set of indications associated with the set of functions, the set of indications being displayed around the second identification.

17. The method of claim 16, wherein the detecting the selection of the second identification comprises:
detecting a contact by the user with the user interface in the informational region in which the second identification is displayed, wherein the contact is maintained for a predetermined amount of time.

18-23. (canceled)

24. The method of claim 12, further comprising:
detecting a selection of the second identification by a user via the user interface;
identifying a set of functions associated with the second application in response to the detecting the selection; and
displaying, in the informational region of the user interface, a set of indications associated with the set of functions, the set of indications being displayed around the second identification.

25. The method of claim 24, wherein the detecting the selection of the second identification comprises:
detecting a contact by the user with the user interface in the informational region in which the second identification is displayed, wherein the contact is maintained for a predetermined amount of time.

26. The method of claim 7, wherein the detecting the selection of the second identification comprises:
detecting a contact by the user with the user interface in the informational region in which the second identification is displayed, wherein the contact is maintained for a predetermined amount of time.

27. The method of claim 15, wherein the communication is implemented using Near Field Communication (NFC) technology.

28. The method of claim 15, wherein the communication includes Global Positioning System (GPS) information.

29. The method of claim 15, wherein the communication is implemented using Bluetooth® technology.

30. The method of claim 15, wherein the communication is implemented using WiFi technology.
